(19) United States
(12) Patent Application Publication
(10) Pub. No.: US 2006/0078735 A1
(43) Pub. Date: Apr. 13, 2006

(54) Method for treating surface of phosphor

(76) Inventors: Seog Hyun Cho, Seoul (KR); Jooho Moon, Seoul (KR); Dongjo Kim, Suwon-si (KR); Sunho Jeong, Seoul (KR); Kyeong Taek Jung, Suwon-si (KR); Hae Soo Ha, Suwon-si (KR)

Correspondence Address: ANDERSON, KILL & OLICK, P.C., 1251 AVENUE OF THE AMERICAS, NEW YORK,, NY, 10020-1182, US

(21) Appl. No.: 11/249,669

(22) Filed: Oct. 12, 2005

(30) Foreign Application Priority Data
Oct. 12, 2004 (KR) 10-2004-0081295

(51) Int. Cl. B05D 7/00; B32B 5/16

(52) U.S. Cl. 428/403; 427/212

(57) ABSTRACT

A method for treating surface of the phosphor particles, which comprises the steps of dispersing the phosphor particles in a solvent, separately dissolving a precursor of a surface-protecting material in a solvent, and combining the resulting dispersion and solution provides phosphor particles having an evenly coated layer of the surface-protecting material.

### FIELD OF THE INVENTION

The present invention relates to a method for efficiently surface-treating phosphor particles.

### DESCRIPTION OF THE PRIOR ART

Phosphors have been used in fluorescent and mercury, and display devices such as cathode ray tube (CRT), plasma display and field emission display. The luminous efficiency of a phosphor depends on its surface structure, composition, and surface crystallinity, and accordingly, there have been made attempts to coat the phosphor particles with a surface-protecting material to protect the phosphors surface properties during the processes of preparation, application, heating, irradiation and others.

Conventionally, a phosphor has been coated by one of liquid-phase coating methods which include a sol-gel method and an electrostatic adsorption in a solution (see U.S. Pat. Nos. 5,858,277; 6,486,589; 5,856,009; 6,001,477; 5,881,154 and 6,013,979; and Korean Patent Publication No. 2000-8995). However, it is very difficult to evenly coat the surface of phosphor particles with a protecting material by such methods.

Accordingly, the present inventors have endeavored to develop an efficient method for treating the surface of the phosphor particles, and have unexpectedly found a particular method that can be used for evenly coating the phosphor particles having various compositions.

### SUMMARY OF THE INVENTION

Accordingly, it is an object of the present invention to provide an efficient method for treating the surface of phosphor particles.

In accordance with one aspect of the present invention, there is provided a method for treating the surface of phosphor particles, comprising the steps of: (i) dispersing phosphor particles in an organic solvent; (ii) dissolving of a precursor of a surface-protecting material, and a polymer in an organic solvent; (iii) mixing the dispersion obtained in step (i) and the solution obtained in step (ii); and (iv) heating the mixture obtained in step (iii).

### BRIEF DESCRIPTION OF THE DRAWINGS

The above and other objects and features of the present invention will become apparent from the following description of the invention, when taken in conjunction with the accompanying drawings, which respectively show:

FIG. 1: Scanning electron microscopy (SEM) image of phosphor particles not surface-treated;

FIGS. 2A to 2C: SEM images of the phosphor particles obtained in Examples 1 to 3, respectively; and

FIG. 3: SEM image of the phosphor particles obtained in Comparative Examples 1.

### DETAILED DESCRIPTION OF THE INVENTION

The inventive method is characterized by the steps of dispersing the phosphor particles having various compositions in a solvent while dissolving a precursor of a surface-protecting material in a solvent, separately, and combining the resulting dispersion and solution.

In step (i), the phosphor particles are homogeneously dispersed in an organic solvent, preferably by ball-milling, to obtain a colloidal phosphor dispersion.

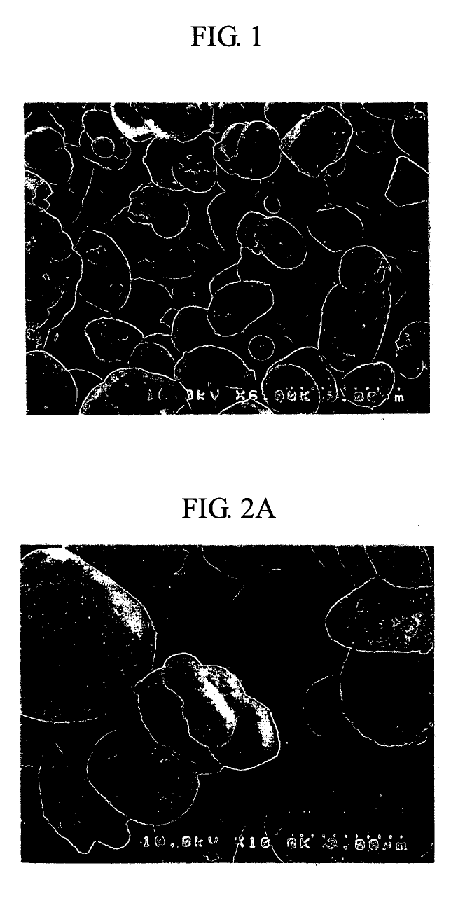

The phosphor particles may be any of phosphor particles conventionally employed in fields of the light sources and displays, preferably particles of a white phosphor such as a mixture of (SrCaBaMg)₅(PO₄)₃Cl:Eu, LaPO₄:CeTb and Y₂O₃:Eu, which has an average-particle size of 5.65 μm, as shown in FIG. 1.

In step (ii), the precursor of the surface-protecting material may be dissolved together with the polymer in the same or another organic solvent to obtain a solution.

The precursor of the surface-protecting material may be selected from the group consisting of precursors of silane, titan, boron, aluminum, zirconium, cesium, alkali metal and yttria-based alcoxides and organic compounds; metal oxide, chloride, nitride, nitrate, acetate and carbonate; and a mixture thereof, preferably a precursor of yttria based metal oxide, more preferably yittrium nitrate hexahydrate (Y(NO₃)₆H₂O), which may be employed in an amount of ranging from 10 to 20% by weight based on the weight of the phosphor particles employed in step (i).

The polymer employed together with the precursor of the surface-protecting material in step (ii) assists the conversion of the precursor into a layer of the surface-protecting material on the surface of the phosphor during heating, by playing the role of a reducing agent, dispersing agent and inhibitor for particle agglomeration. The polymer may be an anionic surfactant, cationic surfactant, nonpolar surfactant, or polymeric reductant, and it is preferably polyvinylpyrrolidone (PVP), polyvinylalcohol, polyethyleneglycol, gelatine or polymethylvinylether.

The organic solvents used in steps (i) and (ii), which may be the same or different, act as a reducing agent of the precursor of the surface-protecting material and also as a dispersing agent for the phosphor particle, and may each be selected from the group consisting of ether, esterether, ester and sugar ester, preferably ester polyethyleneglycol, glycerine ester, sorbitan ester, propyleneglycolester and diethyleneglycol, more preferbly diethyleneglycol (DEG).

Steps (i) and (ii) may be conducted at 50 to 150° C., preferably 100° C.

In step (iii), the dispersion obtained in step (i) and the solution obtained in step (ii) may be combined by stirring, preferably by ball-milling, to homogeneously disperse the phosphor particles in the resulting mixture.

Step (iv) may be carried out at 100 to 200° C., preferably 160° C. to allow the surface-protecting material to react on the surface of the phosphor particles. In step (iv), the precursor is converted to the surface-protecting material, preferably of an amorphous-sol phase, which evenly coats the surface of the phosphor particles.

Further, the thickness of the surface-protecting material coated on the phosphor particles may be adjusted by controlling the time of conducting step (iv), which may be 1 to 10 hours, preferably 6 hours.

The inventive method may further comprise the step of treating the phosphor particles coated with the surface-protecting material obtained in step (iv), in air or a mixture of air and an inert gas selected from the group consisting of argon, nitrogen and helium at 500 to 800° C., preferably 550 to 600° C. to crystallize the amorphous surface-protecting material.

In accordance with the inventive method, it is possible to evenly coat the surface of the phosphor particles having various compositions with a protecting material in concurrence with adjusting the thickness of a coating layer because nucleuses of the protecting material can be directly formed and grown on the surface of the phosphor particles.

The following Examples are given for the purpose of illustration only and are not intended to limit the scope of the invention.

### EXAMPLE 1

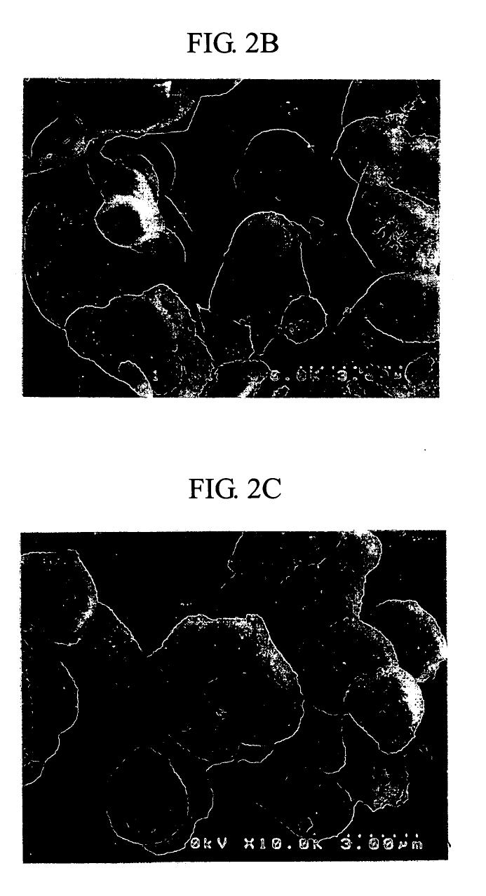

1000 ml of diethyleneglycol (DEG), 11.11 g of Y(NO₃)₆H₂O as a precursor of a surface-protecting material and 9.6 g of polyvinylpyrrolidone (PVP) were placed in a reactor, and stirred at 100° C. to completely dissolve the precursor and PVP in DEG 1000 ml of DEG and 100 g of a white phosphor (a mixture of BaMg₂Al₁₀O₁₈:Eu, LaPO₄:CeTb and Y₂O₃:Eu (42:26:22)) were placed in another reactor, and ball-milled at 100° C. to obtain a homogeneous phosphor dispersion. The resulting dispersion was mixed with the precursor solution in a separate reactor, and stirred at 160° C. for 4 hours to evenly coat the surface of the phosphor particles with a layer of amorphous Y₂O₃, which was treated at 600° C. to obtain phosphor particles coated with a 10˜50 nm thick layer of crystalline Y₂O₃. An electron micrograph of the resulting particles is shown in FIG. 2A.

### EXAMPLE 2

The procedure of Example 1 was repeated except for stirring the mixture of the dispersion and precursor solution at 160° C. for 2 hours instead of 4 hours, to obtain phosphor particles coated with crystalline Y₂O₃. An electron micrograph of the resulting particles is shown in FIG. 2B.

### EXAMPLE 3

The procedure of Example 1 was repeated except for using 25 g of T(NO₃)₆H₂O and 21.6 g of PVP instead of 11.11 g of Y(NO₃)₆H₂O and 9.6 g of PVP, to obtain phosphor particles coated with crystalline Y₂O₃. An electron micrograph of the resulting particles is shown in FIG. 2C.

### COMPARATIVE EXAMPLE 1

The surface of the white phosphor used in Example 1 was treated with Y₂O₃ according to the conventional method for electrostatic adsorption (C. Feldmann, et. al, J. Colloid Interface Sci., 223, 229-234, 2000; J. Merikhi, et. al, J. Colloid Interface Sci., 228, 121-126, 2000; and H. Wang, et. al, J. Am. Ceram. Soc., 85, 1937, 2002).

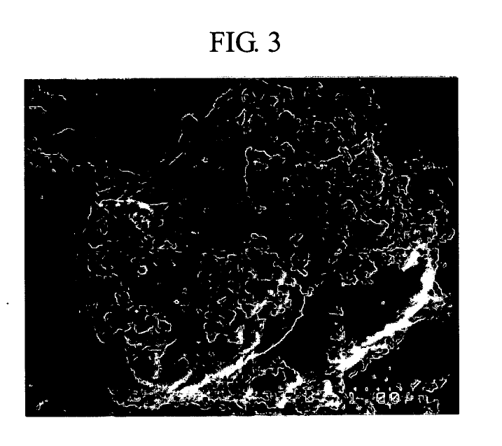

First, 1.5 g of 50 nm yttria sol obtained from Y(NO₃)₆H₂O, 0.15 g of polyacrylic acid (PAA) as a polymeric electrolyte acting as an electrostatic medium, and 10 g of the white phosphor used in Example 1 were mixed by ball-milling for 24 hours with 200 ml of DI(deionized)-water to obtain phosphor particles coated with Y₂O₃ by electrostatic adsorption. An electron micrograph of the resulting particles is shown in FIG. 3.

As shown in FIGS. 2A to 2C and 3, it can be seen that the phosphor particles obtained according to the present invention (FIGS. 2A to 2C) have much more evenly coated layers of the surface-protecting material, as compared with the phosphor particles obtained by electrostatic adsorption, and FIG. 3 reveals the presence of 200 to 500 nm of yttria aggregates formed on the surfaces of the phosphor particles.

As can be seen from the above, it is possible to efficiently treat the surface of phosphor particles having various compositions with a protecting material by dispersing the phosphor particles in a solvent and separately dissolving the precursor of the surface-protecting material in a solvent, followed by combining the resulting dispersion and precursor solution according to the inventive method. Accordingly, the inventive method can be advantageously used in various fields dealing with lighting, cathod ray tube (CRT), plasma display and field emission display.

While the invention has been described with respect to the specific embodiments, it should be recognized that various modifications and changes may be made by those skilled in the art to the invention which also fall within the scope of the invention as defined by the appended claims.

What is claimed is:

1. A method for treating the surface of phosphor particles, comprising the steps of: (i) dispersing phosphor particles in an organic solvent; (ii) dissolving of a precursor of a surface-protecting material, and a polymer in an organic solvent; (iii) mixing the dispersion obtained in step (i) and the solution obtained in step (ii); and (iv) heating the mixture obtained in step (iii).

2. The method of the claim 1, wherein the phosphor is a white phosphor.

3. The method of the claim 1, wherein the surface-protecting material is selected from the group consisting of silane, titan, boron, aluminum, zirconium, cesium, alkali metal and yttria-based organic compounds; metal oxide, chloride, nitride, nitrate, acetate and carbonate; and a mixture thereof

4. The method of the claim 2, wherein the precursor of the surface-protecting material is Y(NO₃)₆H₂O.

5. The method of the claim 1, wherein the amount of the precursor of the surface-protecting material employed in step (ii) is in the range of 10 to 20% by weight based on the weight of the phosphor particle employed in step (i).

6. The method of the claim 1, wherein the polymer is selected from the group consisting of polyvinylpyrrolidone (PVP), polyvinylalcohol, polyethyleneglycol, gelatine and polymethylvinylether.

7. The method of the claim 1, wherein the organic solvent used in step (i) or (ii) is selected from the group consisting of ester polyethyleneglycol, glycerine ester, sorbitan ester, propyleneglycolester and diethyleneglycol.

8. The method of the claim 1, wherein steps (i) and (ii) are each conducted at a temperature of 50 to 150° C.

9. The method of the claim 1, wherein step (iv) is carried out at a temperature of 100 to 200° C.

10. The method of the claim 9, wherein step (iv) is carried out for 1 to 10 hours

11. The method of the claim 1, further comprising the step of treating the phosphor particles coated with the surface-protecting material obtained in step (iv) at a temperature of 500 to 800° C.

12. A surface-treated phosphor obtained by the method of any one of the claims 1 to 11.

13. A luminescent device comprising the surface-treated phosphor of the claim 12.
